(19) United States
(12) Patent Application Publication
(10) Pub. No.: US 2018/0031007 A1
(43) Pub. Date: Feb. 1, 2018

(54) PNEUMATIC LIFT RETRACTION ASSISTANCE APPARATUS AND METHOD

(71) Applicant: MACHINE HEAD INNOVATIONS LLC, LAKE OZARK, MO (US)

(72) Inventor: RICK MOSS, LAKE OZARK, MO (US)

(73) Assignee: MACHINE HEAD INNOVATIONS LLC, LAKE OZARK, MO (US)

(21) Appl. No.: 15/222,223

(22) Filed: Jul. 28, 2016

(51) Int. Cl. F15B 13/042; F15B 20/00

(52) U.S. Cl. CPC F15B 13/042; F15B 20/00

(57) ABSTRACT

A pneumatic lift retraction assistance apparatus is provided to improve withdrawal of a lift. The pneumatic lift retraction assistance apparatus may include a chassis, chamber, vacuum component, vacuum connections, flow regulation component, control component and power component. A method to operate an apparatus to improve withdrawal of a lift using the pneumatic lift retraction assistance apparatus is also provided.

### FIELD OF THE INVENTION

The present disclosure relates to a fluid evacuation assistance apparatus. More particularly, the disclosure relates to an apparatus and method to improve evacuation of a fluid such as air from a chamber.

### BACKGROUND

Lifts are often used to assist with raising and lowering an elevation of a heavy object. For example, boat lifts are used to raise a boat above a water level and lower boats into the water. Various types of lifts exist to assist with this goal, including lifts using hydraulic, cantilever, pontoon floatation, buoyant chambers, and other techniques. Some lifts assist with raising a load by changing the buoyancy of a pneumatic chamber. In one example, a boat lift may change the elevation of a boat by adding or exhausting air from a pneumatic chamber. However, such techniques are typically associated with undesirable disadvantages.

Lifts that use a pneumatic chamber typically rely on filling the chamber with air to raise the lift by increasing buoyancy. To lower the lift, such systems typically allow the air to exhaust from the chamber through an aperture to decrease buoyancy. This aperture typically relies on a passive pressure differential to exhaust air from the chamber. When the lift carries a load, the rate at which air is exhausted may be increased by the weight of the load. However, when the lift is lowered with no load or a small load, the rate at which the air exhausts may be greatly decreased. This undesirable condition is accentuated with an unloaded lift, tall lifts, systems with multiple tanks, and/or systems with one or more large tanks.

At present, no known apparatus or methods are available to solve the problems present in the current state of the art. More particularly, no known apparatus or methods are known to accelerate the lowering of a pneumatic lift in an unloaded configuration. No known apparatus or method provides a simple-to-use option for accomplishing the rapid lowering of a boat lift, whether loaded or unloaded.

Therefore, a need exists to solve the deficiencies present in the prior art. What is needed is an apparatus to improve the lowering of a lift. What is needed is a device to improve retracting speeds of a lift. What is needed is a device to increase the rate to expel air from a chamber. What is needed is a method to quickly withdraw air or fluid from a chamber, such as a lift chamber. What is needed is a method to increase a rate of evacuating air from a chamber of an unloaded boat lift.

### SUMMARY

An aspect of the disclosure advantageously provides an apparatus to improve the lowering of a lift. An aspect of the disclosure advantageously provides a device to improve retracting speeds of a lift. An aspect of the disclosure advantageously provides a device to increase the rate to expel air from a chamber. An aspect of the disclosure advantageously provides a method to quickly withdraw air or fluid from a chamber, such as a lift chamber. An aspect of the disclosure advantageously provides a method to increase a rate of evacuating air from a chamber of an unloaded boat lift.

The apparatus of this disclosure solves the above deficiencies in the current state of the art. This disclosure provides an apparatus and method to increase the rate at with a pneumatic, air-flotation boat lift, and/or hoist may be lowered over the rate of exhausting the air from a chamber solely by natural pressure. The advantages provided by this disclosure are especially beneficial to evacuate air from an unloaded lift, lifts with large chambers, and/or lifts with multiple floatation chambers.

This disclosure provides an apparatus that uses mechanical and electrical components to evacuate air or another fluid from a chamber. The components of this disclosure assist with evacuating the air or other fluid in the flotation tanks quickly, increasing the rate at which a corresponding lift may be lowered over prior inadequate techniques. The components of this disclosure may determine when the lift is lowered to a desired position, for example, a launch point, and disengage the air evacuation assistance. The device may be automatically and/or manually controlled between active, inactive, and other states of operation.

Accordingly, the disclosure may feature a pneumatic evacuation assistance apparatus including a vacuum component, flow regulation component, and control component. The flow regulation component may be operatively connected to the vacuum component. The control component may be communicably connected the vacuum component and the flow regulation component. The control component may selectively affect an operational state of the vacuum component and the flow regulation component. The operational state may include an engaged state and a disengaged state. The vacuum component and the flow regulation component may be operable to evacuate a gas from a chamber during the engaged state. During at least part of the engaged state, the gas may be evacuated from the chamber more expediently than provided by passively exhausting the gas.

In another aspect, the vacuum component may include a motor controllable by the control component and a compressor operatively connected to the motor to affect evacuation of the gas.

In another aspect, the flow regulation component may include a valve and an actuator operatively connected to the valve. The actuator may be manipulable to at least partially control the valve.

In another aspect, the flow regulation component may include a plurality of valves and a coupling assembly operatively connected between at least part of the plurality of valves. The plurality of valves may be operable substantially simultaneously by the actuator via the coupling assembly.

In another aspect, a sensor may be communicably connectable to the control component. The sensor may selectively communicate a signal indicating a condition relating to the chamber. At least part of the signal may be analyzable by the control component to affect the operational state of the vacuum component and the flow regulation component.

In another aspect, the sensor may include a float switch. The control component may analyze the signal to toggle operation between the engaged state when the condition is in substantial compliance with a conditional threshold and the disengaged state when the condition is in substantial noncompliance with the conditional threshold.

In another aspect, a power component may receive main power from a power source and adapt at least part of the main power into usable power.

In another aspect, a safety component may detect a triggering condition during operation of the vacuum component independently, the flow regulation component independently, or the vacuum component and the flow regulation component collectively. Upon detecting the triggering condition, the safety component may communicate with the control component to affect the operational state of the vacuum component independently, the flow regulation component independently, or the vacuum component and the flow regulation component collectively.

In another aspect, the vacuum component may be operable to evacuate the gas from the chamber in the engaged state only.

In another aspect, the vacuum component, the flow regulation component, and the control component may be installable to a chassis.

In another aspect, the vacuum component, the flow regulation component, and the control component may be operatively connected to a pneumatic lift including the chamber to accelerate evacuation of the gas in the chamber while lowering the pneumatic lift in a substantially unloaded state over passively exhausting the gas.

According to an embodiment of this disclosure, a fluid evacuation assistance apparatus may be provided including a vacuum component, flow regulation component, control component, power component, and sensor. The vacuum component may include a motor controllable by the control component and a compressor operatively connected to the motor to affect evacuation of a fluid. The flow regulation component may be operatively connected to the vacuum component. The flow regulation component may include a valve and an actuator operatively connected to the valve. The actuator may be manipulable to at least partially control the valve. The control component may be communicably connected to the vacuum component and the flow regulation component, the control component selectively affecting an operational state of the vacuum component and the flow regulation component. The operational state may include an engaged state and a disengaged state. The power component may receive main power from a power source and adapt at least part of the main power into usable power. The sensor may be communicably connectable to the control component. The sensor may selectively communicate a signal indicating a condition relating to the chamber. At least part of the signal may be analyzable by the control component to affect the operational state of the vacuum component and the flow regulation component. The vacuum component and the flow regulation component may be operable to evacuate the fluid from the chamber during the engaged state. During at least part of the engaged state, the fluid may be evacuated from the chamber more expediently than provided by passively exhausting the fluid.

In another aspect, the flow regulation component may include a plurality of valves and a coupling assembly operatively connected between at least part of the plurality of valves. The plurality of valves may be operable substantially simultaneously by the actuator via the coupling assembly.

In another aspect, a safety component may detect a triggering condition during operation of the vacuum component independently, the flow regulation component independently, or the vacuum component and the flow regulation component collectively. Upon detecting the triggering condition, the safety component may communicate with the control component to affect the operational state of the vacuum component independently, the flow regulation component independently, or the vacuum component and the flow regulation component collectively.

In another aspect, the vacuum component, the flow regulation component, and the control component are installable to a chassis.

According to an embodiment of this disclosure, a method is provided for assisting evacuation of a gas from a chamber. The method may include operating a control component communicably connected to a vacuum component and a flow regulation component to selectively affect an operational state of the vacuum component and the flow regulation component. The operational state may include an engaged state and a disengaged state. The method may include, in the engaged state, configuring the flow regulation component to facilitate flow of the gas from the chamber and enabling the vacuum component to evacuate the gas from the chamber more expediently than provided by passively exhausting the gas. The method may also include, in the disengaged state, configuring the flow regulation component to substantially inhibit evacuation of the gas from the chamber through the flow regulation component and disabling the vacuum component. The flow regulation component may be operatively connected to the vacuum component.

In another aspect, the vacuum component may include a motor controllable by the control component and a compressor operatively connected to the motor to affect evacuation of the gas. The flow regulation component may include a valve and an actuator operatively connected to the valve. The actuator may be manipulable to at least partially control the valve.

In another aspect, the flow regulation component may include a plurality of valves and a coupling assembly operatively connected between at least part of the plurality of valves. The plurality of valves may be operable substantially simultaneously by the actuator via the coupling assembly.

In another aspect, the method may include receiving a signal selectively communicated by a sensor communicably connectable to the control component to indicate a condition relating to the chamber. At least part of the signal may be analyzable by the control component to affect the operational state of the vacuum component and the flow regulation component.

In another aspect, the method may include operating a safety component to detect a triggering condition during operation of the vacuum component independently, the flow regulation component independently, or the vacuum component and the flow regulation component collectively. Upon detecting the triggering condition, the safety component may communicate with the control component to affect the operational state of the vacuum component independently, the flow regulation component independently, or the vacuum component and the flow regulation component collectively.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages of the disclosure described by this disclosure will become more apparent from the following detailed description, along with the accompanying drawings in which like numerals represent like components.

### BRIEF DESCRIPTION OF THE DRAWINGS

FIG. 1 is a block diagram view of an illustrative configuration of the apparatus, according to an embodiment of this disclosure.

FIG. 2 is a block diagram view of an illustrative application of the apparatus, according to an embodiment of this disclosure.

FIG. 3 is a front perspective view of a flow regulation component in a substantially closed configuration, according to an embodiment of this disclosure.

FIG. 4 is a front perspective view of a flow regulation component in an at least partially opened configuration, according to an embodiment of this disclosure.

FIG. 5 is a schematic diagram view of an illustrative control circuit, according to an embodiment of this disclosure.

FIG. 6 is a flow chart view of an illustrative lowering operation for a lift, according to an embodiment of this disclosure.

FIG. 7 is a flow chart view of an illustrative chamber exhausting operation, according to an embodiment of this disclosure.

### DETAILED DESCRIPTION

The following disclosure is provided to describe various embodiments of a pneumatic lift retraction assistance apparatus. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

Various aspects of the present disclosure will now be described in detail, without limitation. In the following disclosure, a pneumatic lift retraction assistance apparatus will be discussed. Those of skill in the art will appreciate alternative labeling of the pneumatic lift retraction assistance apparatus as an air lift lowering device, air evacuation assistance device, pneumatic boat lift assistance apparatus, lift improvement apparatus, the invention, or other similar names. Similarly, those of skill in the art will appreciate alternative labeling of the pneumatic lift retraction assistance method as a lift retracting acceleration method, lift lowering technique, method to evacuate air from a pneumatic lift chamber, method, operation, the invention, or other similar names. Skilled readers should not view the inclusion of any alternative labels as limiting in any way.

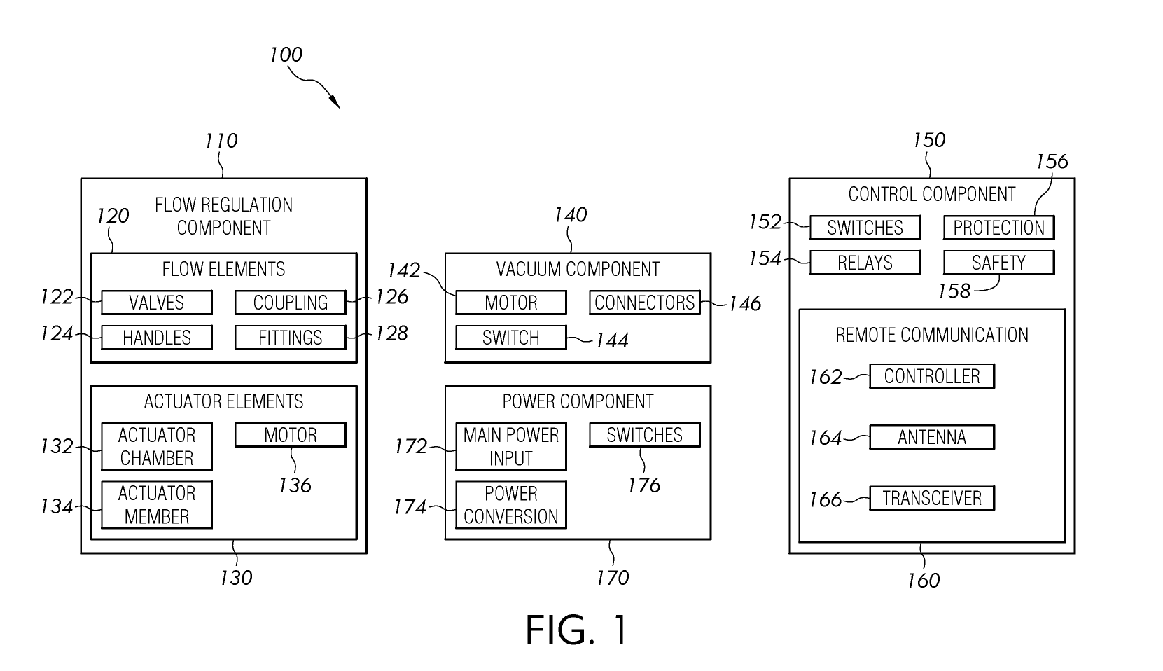

Referring to FIGS. 1-7, the pneumatic lift retraction assistance apparatus will now be discussed in more detail. The pneumatic lift retraction assistance apparatus may include a chassis, chamber, vacuum component, vacuum connections, flow regulation component, control component, power component, and additional components that will be discussed in greater detail below. The pneumatic lift retraction assistance apparatus may operate one or more of these components interactively with other components to improve withdrawal of a lift.

The invention generally relates to an apparatus to improve retracting of a boat lift. The apparatus may use a vacuum to evacuate air from a chamber of a pneumatic boat lift. Use with other types of pneumatic lifts are also considered. The invention is directed to the apparatus used to speed up retraction of the boat lift, and not an entire boat lift structure. The invention may include a chassis, valves, actuator, vacuum motor, chamber, and control features. In some embodiments, the various components may be mounted to the chassis, which may serve as a “backbone” for the apparatus.

Referring to FIG. 1, various components of the apparatus 100 will now be discussed. The components may include a flow regulation component 110, vacuum component 140, control component 150, power component 170, and/or additional components that would be appreciated by a person of skill in the art after having the benefit of this disclosure. The components may be included on a chassis. The chassis may substantially position and/or secure the components at a location in relation to one another.

The chassis will now be discussed in greater detail. The chassis may be constructed using a material onto which components of this disclosure may be mounted. For example, the chassis may be constructed using wood, metals, fibers, fiberglass, composites, plastics, and/or other materials that would be appreciated by a skilled artisan. The chassis may additionally be constructed using a collection of materials.

Additional components may be mounted or otherwise positioned on the chassis. In some embodiments, the chassis may act as a “backbone” for the apparatus. In one example, provided without any intent to limit the invention to this example, various components may be operatively connected to each other via the chassis. The components included in this example will each be discussed in more detail below. In this example, an actuator 130 may be attached to one or more valves 122 via a coupling assembly 126. The valves 122 may be attached to the chassis by valve mounts. A vacuum component 140 may mount to the vacuum chamber. The vacuum component 140 may include a vacuum motor 142.

Additionally, aspects of a power component 170 may be mounted on the chassis. Aspects that may be included by the power component 170 could include a power supply, relays, wiring, remote module, switches, and/or other aspects of the power component 170.

In one embodiment, mechanical components included by the chassis may be at least partially grouped on a side of the chassis, for example, a mechanical side. Additionally, electrical components included by the chassis may be at least partially grouped on a side of the chassis, for example, an electrical side. The mechanical side and the electrical side may be located about opposite to one another with respect to the chassis.

Fittings 128 and one or more vacuum shut-off valves (“VSOCs”) may be attached to the input side of the valves 122. The valves 122 may be attached to the chassis and at least part of the vacuum component 140 via valve mounts, which may additionally be attached to the chassis.

Skilled artisans will appreciate additional embodiments of the apparatus that may have alternative configurations after having the benefit of this disclosure. For example, additional embodiments may include and/or exclude one or more components by the chassis. The chassis may include multiple parts, which may collectively define the chassis. Other embodiments may exclude the chassis. The components and/or a chassis on which the components may be located may be at least partially within an enclosure.

The chamber will now be discussed in greater detail. The chamber may be an at least partially enclosed container into which a fluid may be added or removed. For example, the chamber may be a substantially enclosed container with an aperture to add and remove a fluid, such as air. Throughout this disclosure, references to a fluid is intended to include liquids, gases, and other states of matter capable of at least partially conforming to a container in which it is held. It should be understood that while the chamber is generally discussed throughout this disclosure as receiving, exhausting, evacuating, and otherwise moving air, other fluids may be used in alternative embodiments of the invention.

The chamber may be included by a lift device. For example, the chamber may be at least partially submerged in a liquid, such as water. In an example where one or more chambers are included in a boat lift, the chamber may be variable between a submerged and a floating state. The state of the chamber may be affected by an amount of air present in the chamber. Air may be added to the chamber to increase its buoyancy, causing a lift that is operatively attached to the chamber to rise. Conversely, air may be removed from the chamber to decrease buoyancy, causing the lift that is operatively attached to the chamber to lower. Air may be added to the chamber to increase a pressure within the chamber, displace another fluid from the chamber, or otherwise affect the buoyancy of the chamber.

In one example, air may displace water within at least part of the interior volume of the chamber. The increase of air within the chamber may increase buoyancy and cause an operatively attached lift to rise. To lower the operatively attached lift, the air may be removed from the chamber. The removed air may optionally be replaced by water, decreasing the buoyancy of the chamber. This operation may be repeatable in multiple chambers. In some embodiments, the volume of the chamber may be variable.

The flow regulation component 110 will now be discussed in greater detail. In traditional systems, the flow of air may be affected by creating a pressure differential to force air into the chamber. For example, compressed air may be introduced into the chamber, causing displacement of water from the chamber. However, in traditional systems, exhausting of air is inconveniently performed by relying on the surrounding pressure of the fluid in which the chamber is located and the load applied to an operatively connected lift. When small or null loads are applied to the lift, the air may be exhausted from the chamber at an undesirably slow rate.

The flow regulation component 110 of this disclosure may operate with other components to facilitate evacuation of air from the chamber. The flow regulation component 110 may include one or more flow elements 120 and one or more actuator elements 130. In one example, an actuator element 130 may be operated with multiple flow elements 120 to control a flow of air from a chamber.

The flow elements 120 may include a valve 122, valve handle 124, coupling assembly 126, and additional elements that would be apparent to a person of skill in the art. The valve 122 may control the flow of a fluid. Various types of valves may be included by the system, such as a ball valve, butterfly valve, disc valve, clapper valve, check valve, choke valve, gate valve, piston valve, plug valve, spool valve, or other type of valve that would be appreciated by a skilled artisan.

In one embodiment, the valve 122 may be a ball valve. Ball valves may advantageously provide on/off flow control without pressure drops. The ball valve may include a handle 124, which may be rotated to control the state of the valve 122. For example, the ball valve may be in the on or open position when the handle 124 is substantially parallel with the inlet and outlet of the valve. Conversely, the ball valve may be in the off or closed position when the handle 124 is substantially orthogonal to the inlet and outlet of the valve.

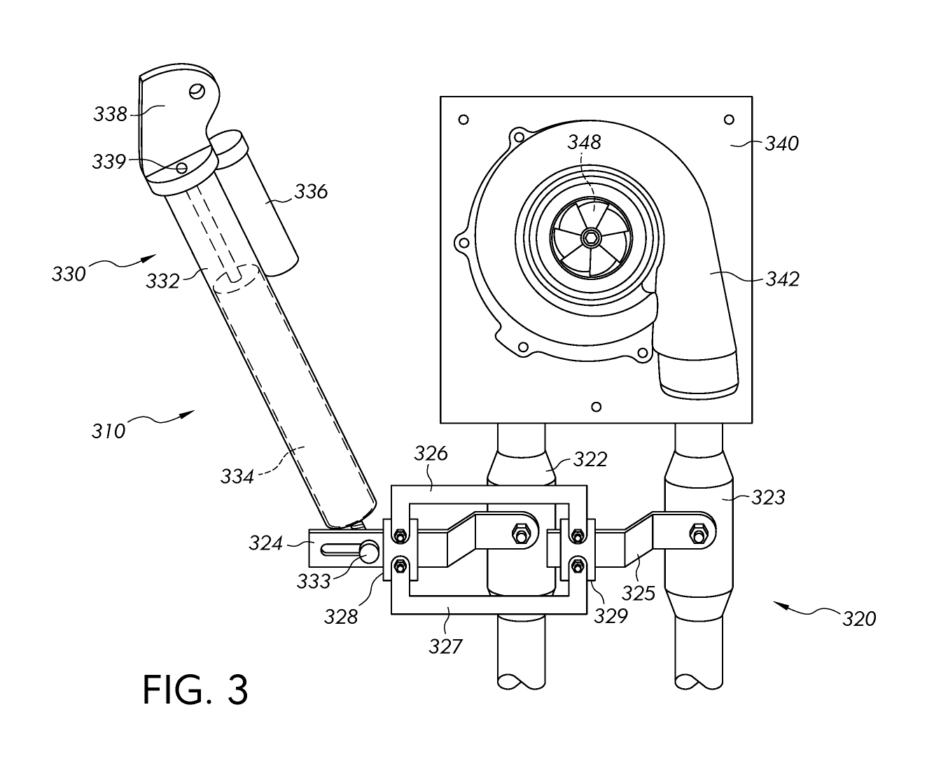

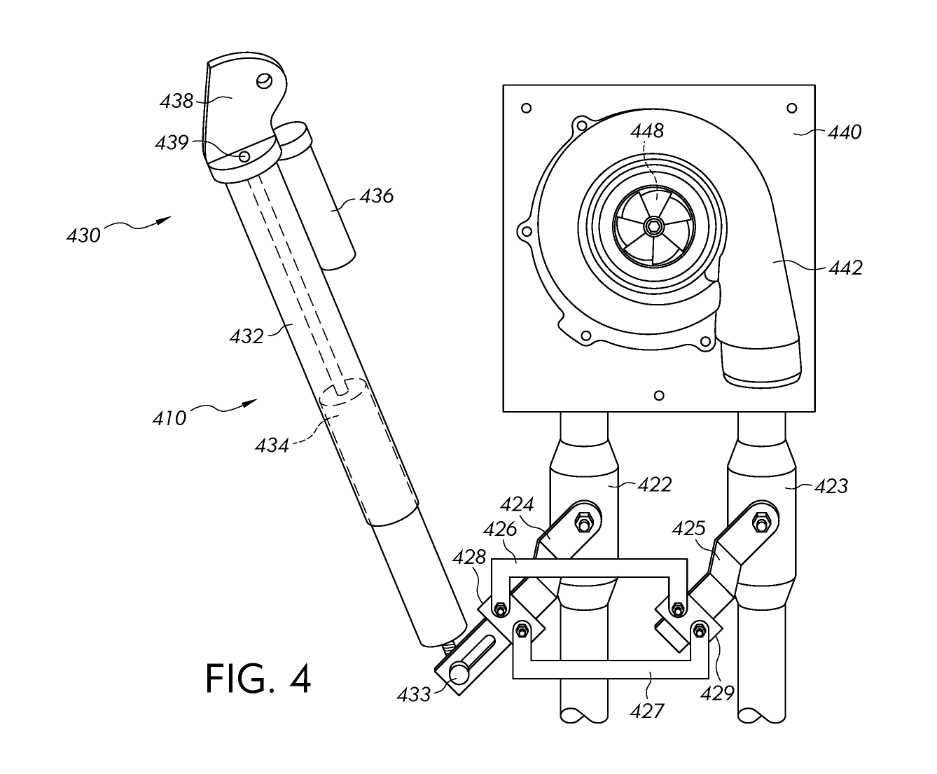

The valve 122 may include a handle 124. A first end of the handle 124 may connect to the actuating portion of the valve 122, the rotation of which may affect the ball of the valve 122 between an open and closed configuration. A distal second end of the handle 124 may be rotated to change the angular configuration of the ball within the valve 122. The distal second end of the handle 124 may be operated manually. Alternatively, the distal second end of the handle 124 may be operated by a connected device such as, for example, an actuator. The operation of the flow elements 120 will be discussed in greater detail below along with FIGS. 3-4.

In one example, multiple ball valves may be included by the flow elements 120, with each valve 122 including an operatively connected handle 124. In an embodiment with multiple valves 122, the handles 124 of the valves 122 may be connected using a coupling assembly 126. The coupling assembly 126 may assist multiple handles to turn substantially simultaneously, allowing the operated valves to operates substantially simultaneously with the coupled valves, each of the coupled valves having about the same state being opened or closed.

In another example, the flow elements 120 may include screw-based valves 122, such as gate valves or globe valves. The valve 122 may be controlled by rotating a disc or wheel attached to the valve stem. In an embodiment of a flow element 120 including multiple screw-based valves, gears may be operatively attached to the stem to control between an opened or closed state of the corresponding valve 122. Additional gears may be included to ensure substantially simultaneous operation of the valves 122. These valves 122 could be operated manually, mechanically, or otherwise. With mechanical operation, the state of the valves 122 may be controlled by an operatively attached actuator or other control device.

The valves 122 may be attached or connected to other components or elements included by this disclosure. For example, the valves 122 may be mounted to other components or elements via valve mounts. In one example, the valve 122 may be attached to a chassis via valve mounts. The valve mounts may provide a reversible attachment to a surface.

The flow elements 120 may additionally include fittings 128. The fittings 128 may be used to operatively connect the valve 122 to pipes and other elements through which a fluid may flow. The fittings 128 may include, without limitation, one or more elbow, coupling, union, reducer, olet, tee, cross, cap, plug, nipple, barb, additional valve, length of flexible material, or other fitting that would be apparent to a person of skill in the art after having the benefit of this disclosure. The fittings 128 may include a withdrawal fitting, which may help withdraw a fluid from a tank or chamber.

The flow regulation component 110 may additionally include actuation elements 130, for example and without limitation, an actuator. The actuator may convert a controllable source of energy into physical movement. The actuator may be at least partially controlled by the control component 150, which will be discussed in greater detail below.

In one embodiment, the actuator may be a linear actuator. An actuator may be connected to the valves 122, which may open or close access between a vacuum component 140 and the chamber. Multiple valves 122 may be connected using a coupling assembly 126. The actuator may be electrically powered. Additionally, the actuator may be controlled using a switch, remote, or other control source, allowing control of the valves 122 without requiring their manual operation. Additional components may be included, such as fuses, breakers, safety shut-off switches (including float switches), and power supplies.

The actuator elements 130 may include an actuator chamber 132, an actuator member 134, and a motor 136. The motor 136 may be provided as a AC or DC motor, and may include a permanent magnet motor, brushless motor, switched reluctance motor, universal AD/DC motor, servo motor, stepper motor, or other types of motors that would be apparent to those of skill in the art. The actuator elements 130 may include gears and screw-type shafts rotatable by the motor 136. In an example wherein the actuator uses a DC motor, the actuator may extend the actuator member 134 out of the chamber as DC power is provided to the motor 136. The actuator may be connected to at least part of the flow elements 120, for example a handle 124 of a valve 122, to control operation of the connected valve 122. Operation of the actuator to control the state of a valve 122 will be discussed in greater detail below along with FIGS. 3-4.

In an alternative embodiment, the actuator elements may include hydraulic elements, such as a chamber, reservoir, and a piston. A fluid may be stored in the reservoir, such as hydraulic fluid or pneumatic pressure. The actuator may displace the fluid between the reservoir and the actuator chamber to move a piston when operated.

The vacuum component 140 will now be discussed in greater detail. The vacuum component 140 may include a motor 142, connectors 146, switches, and/or other elements. The motor 142 may be a vacuum motor, which may affect the air pressure of an attached space during operation. The vacuum motor may operate a compressor, for example, a centrifugal compressor. The compressor may create a pressure differential between an inlet and outlet end of the vacuum component 140. In some embodiments, the vacuum motor and compressor may be included as a vacuum pump.

The vacuum component 140 may include a switch, which may control operation of the motor 142. The switch may be operated manually. Alternatively, the switch may be operated by the control component 150, which will be discussed in greater detail below.

The vacuum component 140 may additionally include vacuum connections, which may operatively connect the vacuum component 140 to other components of this disclosure. For example, the vacuum connections may operatively connect an inlet of a compressor driven by the vacuum motor 142 to the flow regulation component 110. The vacuum component 140 and the flow regulation component 110 may be substantially synchronized so that the vacuum component 140 only operates to draw air if the flow regulation component 110 is in an open state. The vacuum connections may include fittings 128, such as those used with the flow regulation component 110.

In one example involving an applicable boat lift, a submerged pneumatic chamber of the lift may be filled with air, increasing buoyancy and causing the lift (and accompanying boat, if present) to rise. A vacuum motor 142, which may be connected to a compressor, may be operated to create a vacuum or otherwise negative air pressure to assist retraction of the lift. The vacuum may be selectively connected to a chamber, such as the pneumatic chamber used to raise and lower a boat lift. The connection between the vacuum motor 142 and the chamber may be opened and closed using one or more valves 122.

The control component 150 will now be discussed in greater detail. The control component 150 may affect operation of the device. The control component 150 may include switches 152, relays 154, sensors, protection devices 156, safety systems 158, and other elements that would be appreciated by those of skill in the art. These elements may be operatively connected to the various other components of this disclosure.

In a basic example, the switches 152 of the control component 150 may be manipulated to affect a state of the connected components. Switches 152 may be provided to control power, activation, and/or deactivation of the connected components. Delivery of power by the power component 170 may be at least partially controlled by the control component 150 to increase the likelihood of stable and safe power delivery. For example, fuses, breakers, and other power control elements may be included to control delivery of power.

The control component 150 may additionally include one or more relay 154 to affect operation of other components and elements of this disclosure. A relay 154 is an electrically operated switch, which may activate when a low-powered signal is received. Inclusion of relays 154 in the system may advantageously decrease the need for switching high-voltage or high-current circuits directly. In one embodiment, relays 154 may be operated by a signal received from a sensor. For example, relays 154 that control the flow regulation component 110 and the vacuum component 140 may allow operation only when a circuit within a float sensor is closed, reducing the likelihood of operating the connected components after the desired amount of air has been evacuated from the chamber.

Control signals generated by the control component 150 may additionally be used to affect operation of the other communicably connected components. The control component 150 may additionally include remote communication elements 160, which may further include a controller 162, antenna 164, transceiver 166, sensors, and/or computerized circuit. The remote communication elements 160 may detect control signals over a wireless transmission medium, for example, radio-frequency (RF) or infrared (IR). A wireless remote may be operated to control the state of the connected components. The control component 150 may receive instructions from a wirelessly connected device, which may be analyzed to determine a desired state for the components of this disclosure. The control component 150 may then activate and/or deactivate the various components via the switches 152, relays 154, and other elements of the control component 150.

The power component 170 will now be discussed in greater detail. The power component 170 may include various elements to receive, adapt, and/or deliver power to the components of the apparatus. For example, the power component 170 may include a voltage source 172, power conversion element 174, and/or power switches 176.

The power component 170 may include a connection to a power source 172, which may provide main power. This connection may be provided by an electrical plug to be received by an outlet, hardwired into the electrical aspects of a lift system in which the components are installed, or otherwise connected to a power source. Skilled artisans will appreciate additional sources of power to which the apparatus may be connected.

The power component 170 may additionally include power conversion elements 174. For example, the power component 170 may include a transformer to adapt main power received from the voltage source to a format of usable power. For some components, main power may be usable to drive a component or its included elements. The power conversion elements 174 may additionally include an AC/DC converter, which may provide the usable power to components and elements that operate using direct current. Voltages may be further adapted using voltage regulators and/or phase stepping devices. Flow of main power and/or usable power may be controlled via one or more switches, which may operate independently within the power component 170 and/or in coordination with the control component 150. In one embodiment, the power component 170 may include a master switch 176 to provide quick access to cut power, for example, main power, to the entire system. Additional components may be included, such as fuses, breakers, safety shut-off switches (including float switches), and power supplies.

As discussed above, one or more of the components of this disclosure may include safety devices to reduce the likelihood of a failure. The safety devices may include fuses, breakers, cutoff valves 122, backup sensors, redundant circuits, digital control, and main power switches. Skilled artisans will appreciate additional safety devices that would be included within the scope and spirit of this disclosure.

An illustrative example of the apparatus including the components discussed above will now be provided. Skilled artisans will appreciate that this disclosure is not intended to be limited to the follow example in any way. In this example, the vacuum component may be attached firmly to the chassis. A motor of the vacuum component may be attached firmly to the vacuum component, with the inlet side of the vacuum motor operatively connected to the chamber via the flow regulation component. The operative connection between the vacuum component, flow regulation component, and chamber may be substantially sealed to prevent leaking any air or fluid.

Ball valves of the flow control component may be substantially solidly mounted to the chassis and vacuum component via valve mounts, which may be connected approximately adjacent to one side of the vacuum component. The inlet side of the ball valves may have withdrawal fittings of a suitable size and material to which the VSOCs may be attached. The VSOCs may substantially prevent drawing water or another undesired fluid into the vacuum components, such as by opening a connected circuit upon detection of a undesirable pressure level. The aforementioned components may be mounted to the mechanical side of the chassis. Affixed to the opposite side of the chassis, called the electrical side, may be the wiring or circuitry, the relays, the power supply, RF remote module, fuses, breakers, switches, and/or other elements.

The apparatus may be operated substantially automatically. The apparatus may additionally be optionally operated via remote control. A deactivate feature may optionally be provided on the remote control. In another embodiment, the apparatus may be manually operated using the switches on the unit itself.

Various elements or components can be reconfigured to perform the same or similar functions. The components of the system may be arranged and/or mounted to meet packaging, form, and other desirable design goals. The components of the apparatus may advantageously be configured flexibly to meet different packaging requirements without affecting functionality.

Optionally, a safety component may be included to increase the likelihood of safe operation. The safety component may include or be connected to a sensor. The sensor may also be communicably connectable to the control component. The sensor may selectively communicate a signal indicating a condition relating to the chamber, such as air volume, water volume, elevation of a connected lift, or other condition. At least part of the signal may be analyzable by the control component to affect the operational state of the vacuum component and the flow regulation component.

In one embodiment, the sensor may include a float switch. The control component may analyze the signal provided by the sensor, such as the float switch, to toggle an operational state between the engaged state and a disengaged state. The operational state may be set to the engaged state when the condition is in substantial compliance with a conditional threshold. Conversely, the operational state may be set to the disengaged state when the condition is in substantial noncompliance with the conditional threshold. A conditional threshold may include a definable transition between a desired and undesired condition. For example, without limitation, a conditional threshold may be defined as an approximately maximum amount of air that may be safely removed from the chamber before the components should be disengaged.

The safety component may detect a triggering condition during operation of the vacuum component independently, the flow regulation component independently, or the vacuum component and the flow regulation component collectively. The triggering condition may include a failsafe, without limitation. In one example, the triggering condition may include an undesirable pressure being detected by the VSOC. Upon detecting the triggering condition, the safety component may communicate with the control component to affect the operational state of the vacuum component independently, the flow regulation component independently, or the vacuum component and the flow regulation component collectively. In an example that includes the VSOC, the detection of an undesirable pressure level may cause the circuit driving the vacuum component to be opened, for example, via toggling a switch by a change of the vacuum pressure. The float switch, VSOC, and/or other safety components may be used independently and/or in combination with one another.

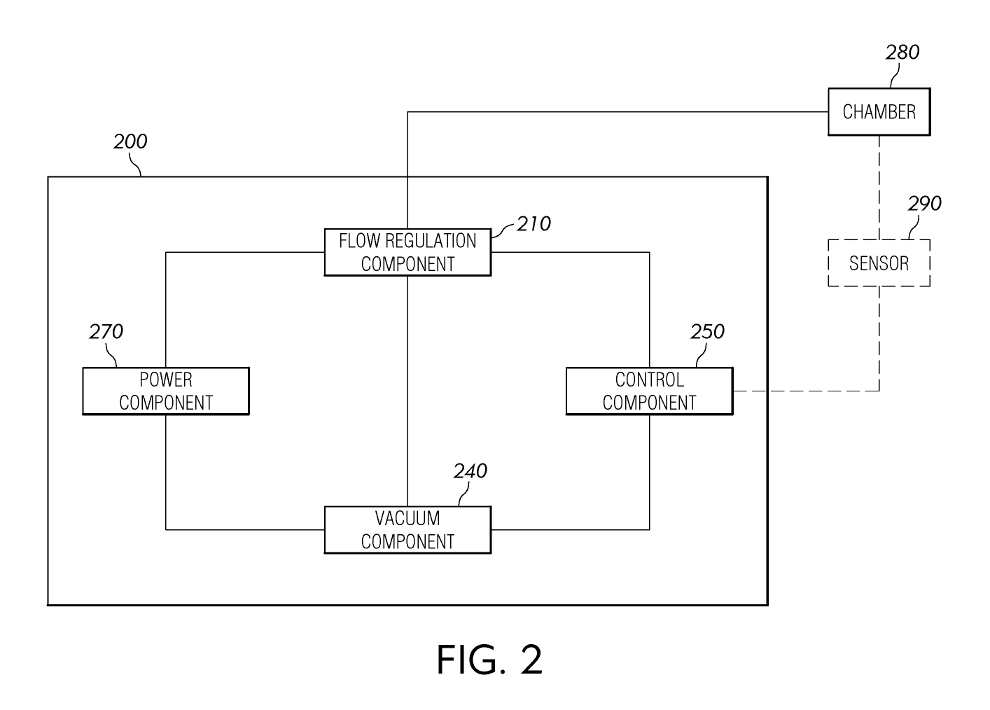

Referring now to the block diagram of FIG. 2, an illustrative implementation of the apparatus will be discussed. Skilled artisans will appreciate that this illustrative implementation is being provided to clearly illustrate one possible embodiment of this disclosure, and is not intended to limit this disclosure in any way.

In this illustrative implementation, the apparatus may be operatively connected to the chamber 280. For example, the apparatus may be connected to the chamber 280 via pipes, tubes, channels, or other pathways that may allow passage of air or another fluid. Skilled artisans will appreciate additional operational connections possible between the apparatus and chamber 280 after having the benefit of this disclosure.

As discussed above along with FIG. 1, an illustrative apparatus 200 may include a flow regulation component 210, vacuum component 240, control component 250, power component 270, and/or additional components that would be apparent to a person of skill in the art.

The flow regulation component 210 may be operatively connected to the vacuum component 240 to affect operation between an engaged state, disengage state, and additional possible states. In the engaged state, the flow regulation component 210 may be configured to allow the flow of air, for example, by opening included valves. Air or another fluid may flow at least partially due to a pressure differential created by a connected vacuum component 240. Conversely, in the disengage state, the flow regulation component 210 may be configured to substantially block the flow of air, for example, by closing the included valves. Additional states may be provided to otherwise control the rate at which a fluid may flow through by manipulation of the flow regulation component 210.

The flow regulation component 210 and the vacuum component 240 may be communicably connected to the control component 250. As discussed above, the control component 250 may affect operation of connected components. For example, the control component 250 may control delivery of useful power to a linear actuator included by the flow regulation component 210, affecting a degree at which a connected valve is opened. In another example, the control component 250 may control delivery of power to a motor included by the vacuum component 240, affecting a level of pressure differential created to draw air through the flow regulation component 210 and from the chamber 280.

The control component 250 may be communicably connected to one or more sensors 290, which may detect a condition in an environment. The sensors 290 may detect the condition directly and/or indirectly. For example, the sensors 290 may include a transducer to directly determine a pressure level within the chamber 280 as a condition. The information from the same pressure sensor 290 may also be analyzed by the control component 250 to indirectly calculate an anticipated rate at which a connected lift is lowering. In another example, the sensors 290 may include a float switch attached to part of the lift. The float switch may detect a condition when the lift is lowered to a desired level, communicating a signal to the control component 250 upon detection of the condition. Skilled artisans will appreciate additional sensors 290 that may be communicably connected to the control component 250 or other components of the apparatus after having the benefit of this disclosure.

The flow regulation component 210 and the vacuum component 240 may additionally be operatively connected to the power component 270. As discussed above, the power component 270 may adapt main power received from a power source into usable power for connected components. The power component 270 may create multiple types of usable power for the various elements of the connected components, including AC and/or DC power in varying voltages and current levels.

Referring now to FIGS. 3-4, an illustrative operation of the flow regulation component and vacuum component 140 will be discussed without limitation. Skilled artisans will appreciate that while the following example is provided to clearly illustrate a possible embodiment of this disclosure, it is not intended to limit this disclosure to only the provided example. Additional embodiments and applications should be apparent to skilled artisans after having the benefit of this disclosure, which are intended to be included within the scope of this disclosure.

In this example, a flow regulation component including two valves will be discussed without limitation. This example was chosen to include two valves in the interest of clearly describing a coupling assembly. Skilled artisans will appreciate additional embodiments with a single valve may be provided for the flow regulation component. Skilled artisans will also appreciate additional valves may be included by the flow regulation component, and thus will not view this example as limiting.

Referring now to FIG. 3, an example of the flow regulation component 310 in the disengaged state will now be discussed. The flow regulation component 310 may include valves 320, including a first valve 322 and a second valve 323. The flow regulation component 310 may additionally include actuator elements 330. The valves 320 may be ball valves, including a floating ball that can be pivoted about an axis to control the flow of a fluid. A stem may extend outwardly from the ball about the axis. The stem may extend outwardly through the body of the valve. An elongated handle may be operatively attached to the stem. More particularly, the handle may include a proximal end attached to the stem and a distal end extending outwardly from the stem. Rotation of the handle may translate to a substantially proportional rotation of the ball within the valve body, affecting the flow characteristics of the valve. The distal end of the valve may include one or more connection points, to which an actuator, coupling assembly, and/or other element may be operatively connected.

The first valve 322 may include a first handle 324 with corresponding proximal and distal ends. The proximal end of the handle 324 may be attached to a ball included by the first valve 322 via its stem. The distal end of the handle 324 may include multiple connection points, facilitating the connection of an actuator 330 and/or a coupling assembly 326, 327. A first plate 328 may be included to facilitate connection of a coupling assembly 326, 327 to the first handle 324.

The second valve 323 may include a second handle 325 with corresponding proximal and distal ends. The proximal end of the handle 325 may be attached to a ball included by the second valve 323 via its stem. The distal end of the handle 325 may include multiple connection points, facilitating the connection of a coupling assembly. A second plate 329 may be included to facilitate connection of a coupling assembly 326, 327 to the second handle 325.

In the disengaged state, the first handle 324 may be oriented substantially orthogonally to the base of the first valve 322. Similarly, in the disengaged state, the second handle 325 may be oriented substantially orthogonally to the base of the second valve 323. This orthogonal configuration for ball valves typically corresponds with a closed state, substantially prohibiting the flow of a fluid through the valve.

A coupling assembly may be operatively connected to the distal ends of the first and second handles 324, 325. In this example, the coupling assembly may include two members, a first coupling assembly member 326 and a second coupling assembly member 327. The first coupling assembly member 326 may include first and second ends, which may be connected to the distal ends of the first and second handles 324, 325. Similarly, the second coupling assembly member 326 may include first and second ends, which may be connected to the distal ends of the handles 324, 325. Alternatively, the first and second coupling assembly members 326, 327 may be intermediately connected to first and second plates 328, 329 located at the distal ends of the first and second handles 324, 325, respectively.

The first and second handles 324, 325 may be oriented substantially parallel to one another via the coupling assembly. During the disengaged state, the first handle 324 and second handle 325 may also be oriented substantially orthogonally to the bodies of the respective valves 322, 323 for each handle 324, 325. An illustrative configuration of the first coupling assembly member 326 and second coupling assembly member 327 in the disengaged state is provided in FIG. 3, without limitation.

An actuator 330 of the flow regulation components may be operatively connected to a handle of the valves at a connection point 333, for example, on handle 324 of the first valve 322. The actuator 330 may include an actuator base 338, which may be installed to a chassis or other location. The actuator 330 may additionally include an actuator pivot location 339, allowing the actuator 330 to pivot about the actuator pivot location 339 as it is operated. Various types of actuators may be used with the flow regulation component, including motor, mechanical, hydraulic, pneumatic, piezoelectric, electromechanical, linear motor, and other actuator configurations that would be appreciated by those of skill in the art. Alternatively, the actuator may include a motor to provide rotational motion, without limitation.

In this example, a motor-driven actuator will be discussed, without limitation. This illustrative actuator 330 may include an actuator element 332, an actuator member 334, and a motor 336. The actuator may include a motor 336, such as a DC motor, without limitation. The rotational motion from the motor may be transferrable between the motor 336 and the actuator member 334 located in the chamber 332 during operation of the flow regulation component.

In the disengaged state, the actuator 330 may be configured in a retracted state. For example, the motor 336 of the actuator 330 may have rotated sufficiently to position the actuator member 334 to be substantially retracted into the chamber. The rotational motion of the motor 336 may be communicated to the actuator member via gears, screw-driven shafts, threaded assemblies, and/or other components that would be apparent to a person of skill in the art. Since the actuator 330 may be mounted to a chassis via the actuator base 338, the actuator may rotate about the actuator pivot 339 to minimize stress on the flow regulation components 320.

Additionally, as the actuator 330 is retracted in the disengaged state, the first handle 324 may be pulled substantially orthogonally to the base of the first valve 322, restricting flow through the valve 322. The first handle 324 may be operatively connected to the second handle 325 via the first and second coupling assembly members 326, 327. Through the coupling assembly, the second handle 325 may be oriented substantially parallel to the first handle 324, corresponding with a substantially orthogonal position relative to the base of the second valve 323. Therefore, the first and second valves 322, 323 may be substantially closed, restricting flow of a fluid between the chamber and the vacuum component 340.

As discussed above, the vacuum component 340 may include a motor 342, compressor 348, and other elements to assist with creating a pressure differential. The vacuum component 340 may be operatively connected to the flow regulation component to affect the flow of a fluid, such as air, between the chamber and the vacuum component 340.

In this example, the vacuum component 340 may be temporarily disabled while in the disengaged state. More particularly, the motor 342 of the vacuum component 340 may be switched off while in the disengaged state. Since the valve elements 320 of the flow regulation component may be closed while in the disengaged state, additionally disabling the motor 342 may avoid unnecessary operation and reduce strain on the motor 342, advantageously decreasing the likelihood that the motor 342 may fail from producing a vacuum on a closed fluid connection.

Referring now to FIG. 4, an example of the flow regulation component 410 in the engaged state will now be discussed. As discussed above, the flow regulation component 410 may include valve elements 420, including a first valve 422 and a second valve 423. The flow regulation component 410 may additionally include actuator elements 430. The valves may be ball valves, including a floating ball that can be pivoted about an axis to control the flow of a fluid.

In the engaged state, the first handle 424 may be oriented approximately inline to the base of the first valve 422. Similarly, in the engaged state, the second handle 425 may be oriented approximately inline to the base of the second valve 423. This approximately inline configuration for ball valves typically correspond with an opened state, substantially allowing uninhibited flow of a fluid through the valve.

In some embodiments, the valves 422, 423 may additionally be oriented in an engaged state by partially rotating the handles 424, 425 away from the orthogonal, closed orientation without fully rotating the handles to be approximately inline with the body of the valves 422, 423. Skilled artisans will appreciate this partially opened configuration can still allow a fluid to pass and may operate as if in an engaged state. In some embodiments, one or more intermediate positions of the handle 424, 425 and corresponding valve balls may correspond with additional states between a fully disengaged state and a fully engaged state.

The first and second handles 424, 425 may be oriented substantially parallel to one another via the coupling assembly. During the engaged state, the first handle 424 and second handle 425 may also be oriented approximately inline to the bodies of the respective valves 422, 423 for each handle 422, 423. An illustrative configuration of the first coupling assembly member 426 and second coupling assembly member 427 in the disengaged state is provided in FIG. 4, without limitation.

Additionally, in the engaged state, the actuator 430 may be configured in an extended state. For example, the motor 436 of the actuator 430 may be operated to drive the actuator member outwardly from the actuator chamber 432, causing the actuator member 434 to be substantially extended from the actuator chamber 432. Since the actuator 430 may be mounted to a chassis via the actuator base 438, the actuator may rotate about the actuator pivot 439 to minimize stress on the flow regulation components 420.

Furthermore, as the actuator 430 is extended in the engaged state, the first handle 424 may be pushed away from an orthogonal orientation with respect to the base of the first valve 422, allowing a fluid to flow through the valve 422. The first handle 424 may be operatively connected to the second handle 425 via the first and second coupling assembly members 426, 427, for example, near connection point 433. The coupling assembly members 426, 427 may optionally be connected to the handles 424, 425 via first and second plates 428, 429. Through the coupling assembly, the second handle 425 may be oriented substantially parallel to the first handle 424, corresponding with a decreasingly orthogonal, and thus increasingly inline position relative to the base of the second valve 423. Therefore, the first and second valves 422, 423 may be substantially opened, permitting flow of a fluid between the chamber and the vacuum component 440.

As discussed above, the vacuum component 440 may include a motor 442, compressor 448, and other elements to assist with creating a pressure differential. The vacuum component 440 may be operatively connected to the flow regulation component 420 to affect the flow of a fluid, such as air, between the chamber and the vacuum component 440.

In this example, the vacuum component 440 may be temporarily operated while in the engaged state. More particularly, the motor 442 of the vacuum component 440 may be switched on while in the engaged state. Since the valves of the flow regulation component may be opened while in the engaged state, additionally enabling the motor 442 to advantageously create the desired pressure differential to evacuate air or another fluid from a chamber connected through the flow regulation component.

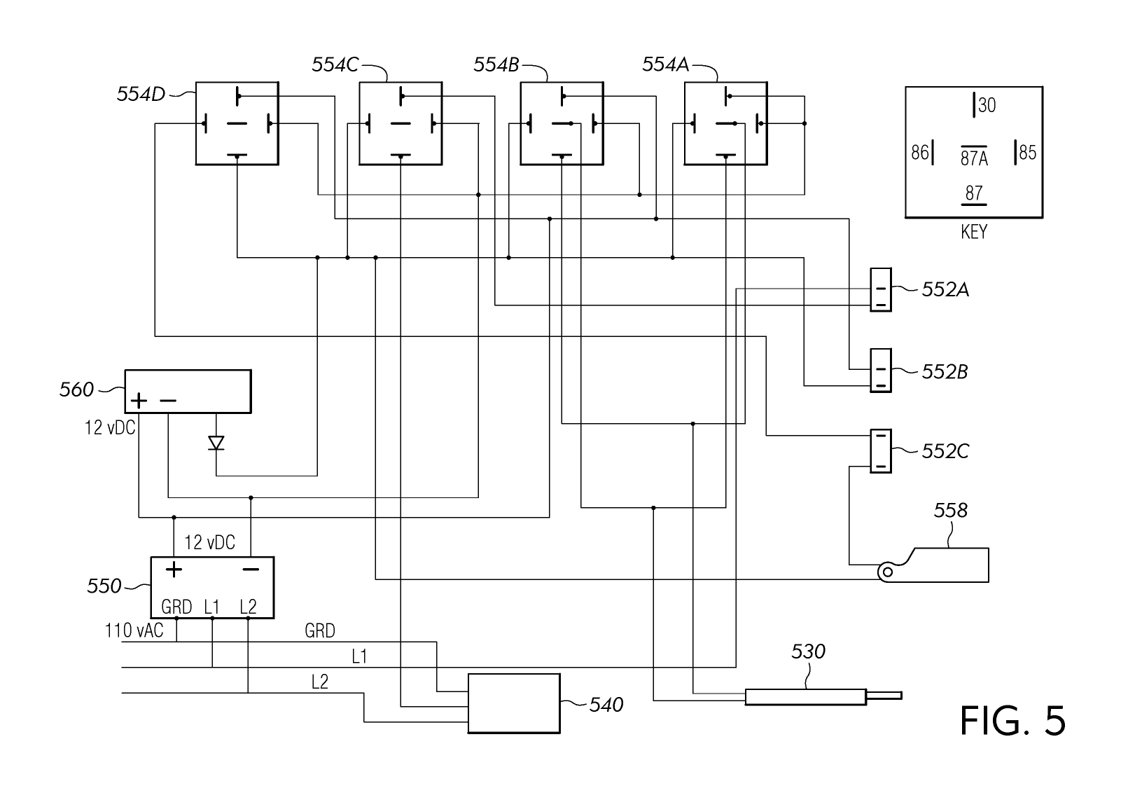

Referring now to the schematic diagram of FIG. 5, an illustrative circuit connecting the components of this disclosure will be discussed without limitation. Skilled artisans will appreciate that this example circuit is presented to illustrate a possible embodiment and is not intended to limit this disclosure in any way.

The circuit may include various components described throughout this disclosure, including various elements of those components. For example, the circuit may include aspects of a flow regulation component, vacuum component, control component, and power component.

The circuit may include a power component 570, which may receive main power from a power source. Additional components and elements may be configured to operate using main power, for example, motors and AC devices. The power component 570 may adapt the main power received from the power source into usable power. In the example provided by the circuit diagram of FIG. 5, the main power may be 110 VAC. This main power may be adapted to usable power, for example 12 VDC, which may be used by other aspects of the system. Skilled artisans will appreciate additional forms of usable power, which may have different voltages, currents, or AC/DC characteristics, may be adapted by the power component 570.

The circuit may include elements of the control component. For example, the circuit may include switches, relays, and remote communication elements. These elements of the control component may affect the operation of other connected components.

The illustrative circuit may include switches 552A, 552B, and 552C to control operation of connected components. The illustrative circuit may additionally include relays 554A, 554B, 554C, and 554D to control operation of connected components. The relays may work in cooperation with the switches to control connected components. The relays may be a 5-pin automotive relay that would be appreciated by those of skill in the art. For example, the relays may be a Bosch-type relay that includes a high power feed pin (30), relay coil ground pin (85), relay coil feed pin (86), normally-open high power output pin (87), and normally-closed high power output pin (87a). Skilled artisans will appreciate additional types of relays that may be used, without limitation. The illustrative circuit may additionally include a remote communication element 560, which may further control aspects of the circuit.

Switch 552A may represent a power switch, which may control power transmission between the main power and the high power feed pin of a relay, such as relay 554C. The power switch 552A may control power delivery through the relay 554C to elements of the vacuum component 540 and flow control component, for example, the actuator 530. Manipulation of the power switch 552A may control the operational capacity of connected relays and other components.

The illustrative circuit additionally includes switches 552B and 552C, which may activate or deactivate the system, respectively. The activate switch 552B may control power transmission between the high power feed pins of relays 554B and 554D, the normally-closed high power output pin of relay 554D, a trigger-out diode connected to an optional remote communication element 560, and a terminal of a safety switch 558. The safety switch 558 may be a float switch. In one embodiment, one or more switch driven by VSOC may be included in series with the safety switch. Operation of the activate switch 552B may enable operation of the system to evacuate air from a chamber.

The deactivate switch 552C may control power transmission between the relay coil feed pin of relay 554D and the safety switch. Operation of the deactivate switch 552C may temporarily deactivate one or more components connected to relay 554D.

This illustrative system includes four relays—554A, 554B, 554C, and 554D. Skilled artisans will appreciate configurations with more or less relays to also be included within the scope and spirit of this disclosure. Relays 554A an 554B may collectively affect operation of a connected actuator 530. For example, a first terminal of the actuator 530 may be operatively connected to the normally-closed high power output pin of relay 554A and the normally-open high power output pin of relay 554B. Additionally, a second terminal of the actuator 530 may be operatively connected to the normally-open high power output pin of relay 554A and the normally-closed high power output pin of relay 554B. Operation of the actuator 530 may be affected by manipulation of the activate switch 552B, which may open or close power delivery to the connected actuator 530.

Relay 554C may be operatively connected to the power switch 552A and vacuum component 540. For example, the high power feed pin of relay 554C may be connected to the power switch 552A and may receive power when the switch 552A is closed. The normally-open high power output pin of relay 554C may be connected to a terminal of an element included by the vacuum component 540, such as a motor. The relay 554C may affect the flow of current between the switch 552A and vacuum component 540 through use of a connected trigger, for example, as may be provided by the activate switch 552B and/or remote communication element 560.

Relay 554D may be operatively connected to a remote communication component 560, activate switch 552B, and/or other relays, which may facilitate locally and/or remotely controlling operation of the connected components. For example, the high power feed pin of relay 554D may be operatively connected to the positive usable power output terminal of the power component 570. The normally-open high power output of relay 554D may be operatively connected to relay coil feed pins of the remaining relays 554A, 554B, and 554C. Relay 554D may be configured such that when a current is passed through its coil, the contact in the relay 554D may close. This may allow current to flow through the feed and the normally-open high power pins and to the triggering pins of the other relays.

Skilled artisans will appreciate that while this illustrative diagram is provided to clearly describe one embodiment of this disclosure, it is not intended to limit this disclosure to the above discussed embodiment. Additional embodiments may include alternative relay configurations, alternative control techniques, additional components, omitted components, or otherwise different configurations consistent with this disclosure.

In operation, a method may be provided to improve withdrawal of a lift. Those of skill in the art will appreciate that the following methods are provided to illustrate an embodiment of the disclosure, and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

The invention solves the problem of slow retraction characteristics of pneumatic boat lifts. Prior boat lifts rely on passively exhausting air from a chamber of the boat lift, relying on atmospheric pressure. The invention includes a novel, controllable apparatus that can create a negative air pressure, speeding the evacuation of air from the chamber of the boat lift. As air is more quickly withdrawn from the boat lift's chamber, its buoyancy is more quickly reduced, and the boat lift is more quickly withdrawn from its extended position. The benefits of the invention are especially prevalent when the boat lift is unloaded, since weight is a significant factor for speed of withdrawal in prior designs.

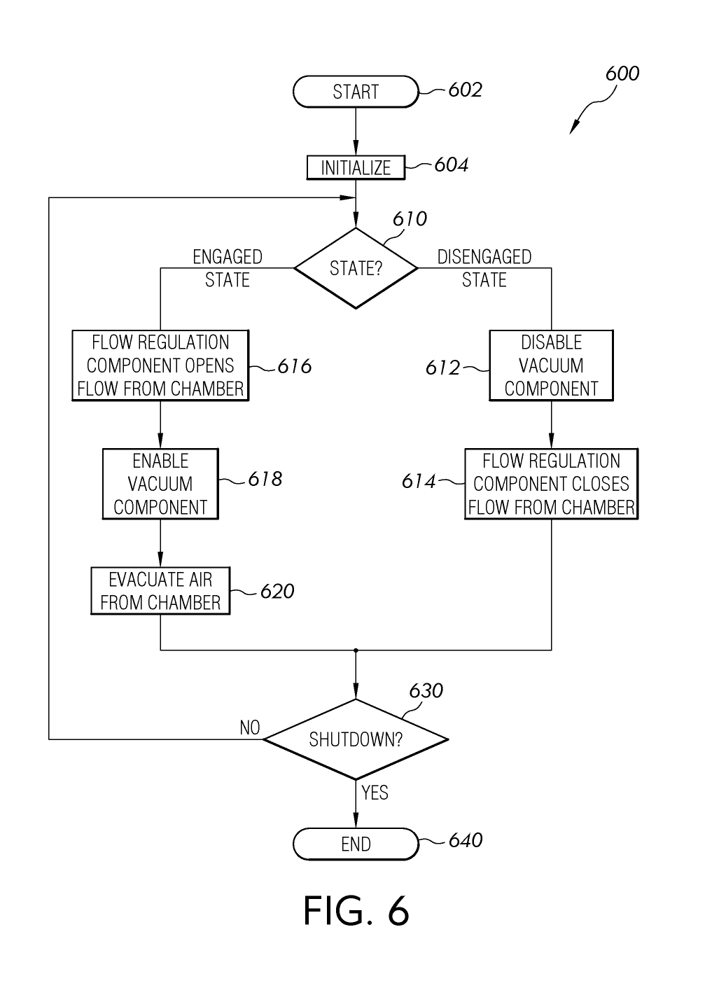

Referring now to flowchart 600 of FIG. 6, an illustrative method for a lowering operation for a lift will be described, without limitation. Starting with block 602, the operation may begin by optionally initializing the components (Block 604). The initialization may ensure its components are set in the desired states and ready to be switched or otherwise set to the desired state of operation. For example, the operation may ensure all components are initialized respective to a disengaged state.

The operation may then determine if a command or signal is received to affect whether to proceed in an engaged or disengaged operational state (Block 610). If it is determined at Block 610 that a disengaged state is desired, the operation may manipulate the flow regulation component and/or vacuum component to enter a disengaged state. For example, the operation may disable the vacuum component, effectively stopping the pressure differential used to affect the flow from the chamber (Block 612). Additionally, the operation may retract a connected actuator to close the valves of the flow regulation component (Block 614). Switching or otherwise controlling the components may be handled by the control component.

If it is determined at Block 610 that an engaged state is desired, the operation may manipulate the flow regulation component and/or vacuum component to enter an engaged state. For example, the operation may extend a connected actuator to open the valves of the flow regulation component (Block 616). Additionally, the operation may enable the vacuum component, effectively starting the pressure differential used to affect the flow from the chamber (Block 618). Switching or otherwise controlling the components may be handled by the control component. The apparatus may then evacuate air from a connected chamber (Block 620).

It may be determined at Block 630 whether to terminate the operation. If it is determined at Block 630 that the operation should continue, the operation may again determine whether to proceed in an engaged state or a disengaged state, as provided at Block 610. If it is determined at Block 630 that the operation should not continue, the operation may terminate at Block 640.

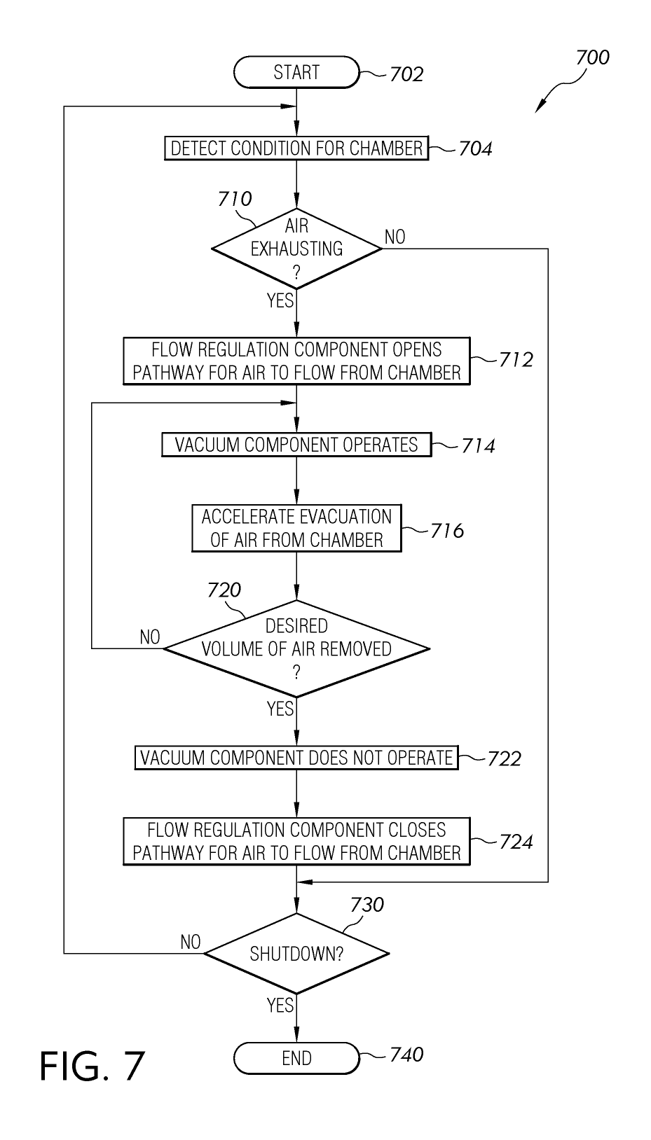

Referring now to flowchart 700 of FIG. 7, an illustrative method for a chamber exhausting operation will be described, without limitation. Starting with block 702, the operation may begin by detecting a condition of the chamber (Block 704). This operation may include receiving a signal from a sensor located in or about the chamber.

The operation may then determine whether the signal indicates that air is being exhausted from the chamber (Block 710). If it is determined that no air is being exhausted at Block 710, it may then be determined whether to continue operation at Block 730.

If it is determined at Block 710 that air is being exhausted from the chamber, the operation may manipulate the flow control component to open a pathway from the air in the chamber to at least part of the components of this disclosure (Block 712). The operation may additionally begin operation of the vacuum component 140 (Block 714). For example, the operation may switch on the motor of the vacuum component to drive a compressor, which may accelerate evacuation of air from the chamber (Block 716).

The operation may next determine if a desired volume of air has been evacuated from the chamber (Block 720). If it is determined at Block 720 that more air is desired to be evacuated from the chamber, the operation may continue to operate the vacuum component, as provided at Block 716. If it is determined at Block 720 that a desired amount of air has been evacuated from the chamber, the method may conclude operation of the vacuum component (Block 722). The operation may additionally manipulate the flow regulation component close flow of air from the chamber to the vacuum component (Block 724).

It may be determined at Block 730 whether to terminate the operation. If it is determined at Block 730 that the operation should continue, the operation may again detect a condition of the chamber, as provided at Block 704. If it is determined at Block 730 that the operation should not continue, the operation may terminate at Block 740.

While various aspects of the disclosure have been described above, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A pneumatic evacuation assistance apparatus comprising:
a vacuum component;
a flow regulation component operatively connected to the vacuum component; and
a control component communicably connected to the vacuum component and the flow regulation component, the control component selectively affecting an operational state of the vacuum component and the flow regulation component, the operational state comprising an engaged state and a disengaged state;
wherein the vacuum component and the flow regulation component are operable to evacuate a gas from a chamber during the engaged state;
wherein during at least part of the engaged state, the gas is evacuated from the chamber more expediently than provided by passively exhausting the gas.

2. The apparatus of claim 1, wherein the vacuum component comprises:
a motor controllable by the control component; and
a compressor operatively connected to the motor to affect evacuation of the gas.

3. The apparatus of claim 1, wherein the flow regulation component comprises:
a valve; and
an actuator operatively connected to the valve;
wherein the actuator is manipulable to at least partially control the valve.

4. The apparatus of claim 3, wherein the flow regulation component comprises:
a plurality of valves; and
a coupling assembly operatively connected between at least part of the plurality of valves;
wherein the plurality of valves is operable substantially simultaneously by the actuator via the coupling assembly.

5. The apparatus of claim 1, further comprising:
a sensor communicably connectable to the control component;
wherein the sensor selectively communicates a signal indicating a condition relating to the chamber;
wherein at least part of the signal is analyzable by the control component to affect the operational state of the vacuum component and the flow regulation component.

6. The apparatus of claim 5, wherein the sensor comprises;
a float switch;
wherein the control component analyzes the signal to toggle operation between the engaged state when the condition is in substantial compliance with a conditional threshold and the disengaged state when the condition is in substantial noncompliance with the conditional threshold.

7. The apparatus of claim 1, further comprising a power component to receive main power from a power source and adapt at least part of the main power into usable power.

8. The apparatus of claim 1, further comprising:
a safety component to detect a triggering condition during operation of the vacuum component independently, the flow regulation component independently, or the vacuum component and the flow regulation component collectively;
wherein upon detecting the triggering condition, the safety component communicates with the control component to affect the operational state of the vacuum component independently, the flow regulation component independently, or the vacuum component and the flow regulation component collectively.

9. The apparatus of claim 1, wherein the vacuum component is operable to evacuate the gas from the chamber in the engaged state only.

10. The apparatus of claim 1, further comprising:
a chassis;
wherein the vacuum component, the flow regulation component, and the control component are installable to the chassis.

11. The apparatus of claim 1, wherein the vacuum component, the flow regulation component, and the control component are operatively connected to a pneumatic lift comprising the chamber to accelerate evacuation of the gas in the chamber while lowering the pneumatic lift in a substantially unloaded state over passively exhausting the gas.

12. A fluid evacuation assistance apparatus comprising:
a vacuum component comprising:
a motor controllable by the control component, and
a compressor operatively connected to the motor to affect evacuation of a fluid;
a flow regulation component operatively connected to the vacuum component comprising:
a valve, and
an actuator operatively connected to the valve,
wherein the actuator is manipulable to at least partially control the valve;
a control component communicably connected to the vacuum component and the flow regulation component, the control component selectively affecting an operational state of the vacuum component and the flow regulation component, the operational state comprising an engaged state and a disengaged state;
a power component to receive main power from a power source and adapt at least part of the main power into usable power; and
a sensor communicably connectable to the control component;
wherein the sensor selectively communicates a signal indicating a condition relating to the chamber;
wherein at least part of the signal is analyzable by the control component to affect the operational state of the vacuum component and the flow regulation component;
wherein the vacuum component and the flow regulation component are operable to evacuate the fluid from the chamber during the engaged state;
wherein during at least part of the engaged state, the fluid is evacuated from the chamber more expediently than provided by passively exhausting the fluid.

13. The apparatus of claim 12, wherein the flow regulation component comprises:
a plurality of valves; and
a coupling assembly operatively connected between at least part of the plurality of valves;
wherein the plurality of valves is operable substantially simultaneously by the actuator via the coupling assembly.

14. The apparatus of claim 12, further comprising:
a safety component to detect a triggering condition during operation of the vacuum component independently, the flow regulation component independently, or the vacuum component and the flow regulation component collectively;
wherein upon detecting the triggering condition, the safety component communicates with the control component to affect the operational state of the vacuum component independently, the flow regulation component independently, or the vacuum component and the flow regulation component collectively.

15. The apparatus of claim 12, further comprising:
a chassis;
wherein the vacuum component, the flow regulation component, and the control component are installable to the chassis.

16. A method of assisting evacuation of a gas from a chamber comprising:
(a) operating a control component communicably connected to a vacuum component and a flow regulation component to selectively affect an operational state of the vacuum component and the flow regulation component, the operational state comprising an engaged state and a disengaged state;
(b) in the engaged state:
i. configuring the flow regulation component to facilitate flow of the gas from the chamber, and
ii. enabling the vacuum component to evacuate the gas from the chamber more expediently than provided by passively exhausting the gas;
(c) in the disengaged state:
iii. configuring the flow regulation component to substantially inhibit evacuation of the gas from the chamber through the flow regulation component, and
iv. disabling the vacuum component;
wherein the flow regulation component is operatively connected to the vacuum component.

17. The method of claim 16, wherein:
the vacuum component comprises:
a motor controllable by the control component, and
a compressor operatively connected to the motor to affect evacuation of the gas; and
the flow regulation component comprises:
a valve, and
an actuator operatively connected to the valve,
wherein the actuator is manipulable to at least partially control the valve.

18. The method of claim 16, wherein the flow regulation component comprises:
a plurality of valves; and
a coupling assembly operatively connected between at least part of the plurality of valves;
wherein the plurality of valves is operable substantially simultaneously by the actuator via the coupling assembly.

19. The method of claim 16, further comprising:
(d) receiving a signal selectively communicated by a sensor communicably connectable to the control component to indicate a condition relating to the chamber;
wherein at least part of the signal is analyzable by the control component to affect the operational state of the vacuum component and the flow regulation component.

20. The method of claim 16, further comprising:
(e) operating a safety component to detect a triggering condition during operation of the vacuum component independently, the flow regulation component independently, or the vacuum component and the flow regulation component collectively;
wherein upon detecting the triggering condition, the safety component communicates with the control component to affect the operational state of the vacuum component independently, the flow regulation component independently, or the vacuum component and the flow regulation component collectively.
